(19) United States
(12) Patent Application Publication
(10) Pub. No.: US 2008/0149753 A1
(43) Pub. Date: Jun. 26, 2008

(54) TAPE CARTRIDGE

(75) Inventors: Toshiro Nishiwaki, Osaka (JP); Keiji Ban, Osaka (JP)

Correspondence Address: BIRCH STEWART KOLASCH & BIRCH, PO BOX 747, FALLS CHURCH, VA, 22040-0747, US

(73) Assignee: Hitachi Maxell, Ltd., Ibaraki-shi (JP)

(21) Appl. No.: 11/947,620

(22) Filed: Nov. 29, 2007

(30) Foreign Application Priority Data
Nov. 30, 2006 (JP) 2006-324859

(51) Int. Cl. G11B 23/04

(52) U.S. Cl. 242/347

(57) ABSTRACT

A tape cartridge has a housing having upper and lower walls defining an interior therebetween, a pair of tape winding elements provided on left and right sides of the interior of the housing, the tape winding elements being supported for rotation by the upper and lower walls of the housing, a tape wound around the tape winding elements, a restriction sheet provided between the upper wall of the housing and windings of the tape, and a restriction means made of a lower bouncing material. The restriction means is provided in a region on a rear side of a line connecting centers of the tape winding elements and opposing the windings of the tape and also between the upper wall of the housing and the restriction sheet so that, when the restriction sheet is forced toward the upper wall by an edge of laterally moving tape, the restriction means receives the forced restriction sheet and then resiliently returns the restriction sheet toward the tape winding to prevent a misaligned winding of the tape.

### FIELD OF THE INVENTION

The present invention relates to a tape cartridge and, in particular, to a tape cartridge including flange-less winding members.

### BACKGROUND OF THE INVENTION

A tape cartridge includes a pair of tape winding elements around which a tape is wound. Conventionally, two types of winding elements are employed, one with flanged winding elements and the other with flange-less winding elements. The tape cartridge including the flange-less winding elements is discloses in, for example, the Japanese Patent Publication No. H11-273303 A. Compared with the tape cartridge with the flanged winding elements, the tape cartridge with the flange-less winding elements has a disadvantage that, due to the lack of the flange, the tape being wound is likely to move laterally and thereby to cause a misalignment of the tape edges. In order to prevent the misaligned windings, there has been proposed to provide a restriction sheet such as friction sheet or slipping sheet between the upper and lower walls of the tape housing and the winding elements.

Specifically, the Japanese Utility Model Publication JP H01-27191 B discloses a tape cartridge with the restriction sheet. The restriction sheet has a pair of parallel linear ribs or projections extending laterally, i.e., parallel to a line connecting centers of the winding elements, and provided in both sides of the line, i.e., front side and the rear side. The tips of the projections are brought into contact with the internal surfaces of the upper housing-wall, so that the restriction sheet is resiliently forced to the tape edges and thereby to prevent the misaligned windings of the tape.

According to the Japanese Patent publication JP H11-273303 A, the self-preserving restriction sheet simply restricts the tape edge. Disadvantageously, the winding element can be inclined due to, for example, the variations of the tape tension at the winding of the tape. In this instance, the inclination causes the winding element and/or edges of the tape being wound around the tape winding element to make contacts with and thereby deflect the restriction sheet, which results in that the deflected restriction sheet is unable to prevent the misaligned winding of the tape. The misaligned windings may cause an unstable tape running and an unwanted lateral movement of the tape, which may result in a defective recording and therefore prohibits an applicability of the tape cartridge to external, high density recording media for computers.

According to the Japanese Utility Model publication No. H01-27191 B, the provision of the linear ribs for the restriction sheet allows the restriction sheet to make elastic contacts with the tape winding elements and the edges of the tape being wound around the winding element, which prevents the misalignment of the tape to some extent. However, the restriction sheet is forced only by the elasticity of the restriction sheet and the projections, which is insufficient to restrict the lateral movements of the winding tape and therefore is incapable of preventing the misalignment of the tape in a reliable manner.

The forward inclination of the tape windings may cause a peripheral edge of the windings to make frictional contact with the upper wall of the tape housing, which increases the torque for rotating the winding elements and/or damages the tape edges. Also, if the torque exceeds a predetermined value, the tape drive may be forced to be halted and, as a result, it can be out of service in the future.

Assuming that restriction ribs are formed on the internal surface of the housing for supporting the restriction sheet. This may prevent the inclination of the tape winding elements while restricting the misalignment of tape windings. However, since the combination of the restriction sheet and the ribs does not allow any lateral movement of the tape, the edge of the misaligning tape may bend by the contact with the restriction sheet. In particular, since the substrate of the high density recording tape is so thinned as to increase an amount of recording data, so that such tape can bend backward easily and the edge thereof can wear out in a short period of time.

### SUMMARY OF THE INVENTION

A purpose of the present invention is to provide a tape cartridge capable of preventing not only an inclination of the tape winding element but also the misalignment of the recording tape wound.

Another purpose of the present invention is to provide a tape cartridge with a high density recording ability and suitable for an external recording medium for computers, in which a thinned tape can be wound in a well-aligned manner without being damaged.

Therefore, a tape cartridge of the present invention has

a housing having upper and lower walls defining an interior therebetween;

a pair of tape winding elements provided on left and right sides of the interior of the housing, the tape winding elements being supported for rotation by the upper and lower walls of the housing;

a tape wound around the tape winding elements;

a restriction sheet provided between the upper wall of the housing and windings of the tape; and

a restriction means made of a lower bouncing material, the restriction means being provided in a region on a rear side of a line connecting centers of the tape winding elements and opposing the windings of the tape and between the upper wall of the housing and the restriction sheet so that, when the restriction sheet is forced toward the upper wall by an edge of laterally moving tape, the restriction means receives the forced restriction sheet and then resiliently returns the restriction sheet toward the tape winding to prevent a misaligned winding of the tape.

According to the present invention, the misaligned winding of the tape which might otherwise be cause in winding and unwinding of the tape around the winding element is prevented. Also, the inclination of the tape winding is restricted, so that the tape is properly wound around tape winding elements free without causing any damage to the edges of the tape even with smaller thickness. This ensures to provide tape cartridges suitable for the external recording medium for computers, in which a thinner tape base is employed in order to increase the data recording density and amount of the tape.

Also, the inclination of the tape winding is prevented by the combination of the restriction sheet and the restriction means. This prevents frictional contacts of a portion of the tape winding with the upper housing-wall and any possible rotational torque increase of the tape winding which would otherwise cause an emergency stop of the tape drive and the resultant damages thereof, which increases a reliability of the tape cartridge.

Another aspect of the present invention is the tape cartridge in which the restriction means is secured directly or indirectly to the upper wall of the housing. According to this aspect of the invention, a variety of arrangements can be made to the restriction means.

Another aspect of the present invention is the tape cartridge in which the restriction means is made of resilient rubber or plastic material. According to this aspect of the invention, the restriction member makes a contact with the restriction sheet through an extended contact area formed by the compressive deformation of the restriction means, so that the force applied to the restriction sheet from the

Another aspect of the present invention is the tape cartridge in which the restriction means has an elongate rod-like restriction member made of resilient rubber or plastic material, the restriction member being extended from left to right in the region. According to this aspect of the invention, the restriction member begins to return the restriction sheet to restrict the misaligning tape edges into the proper positions from when the tape is wound around the tape winding element to a certain extent and thereby to prevent the misalignment of the tape. Also, this arrangement of the restriction member prevents unnecessary contacts between the restriction sheet and the tape windings to minimize the frictional force to be applied from the restriction sheet against the tape windings.

Another aspect of the present invention is the tape cartridge in which the restriction means has a plurality of restriction members disposed separately in the rear region, each of the restriction members being made of a compressive coil spring. According to this aspect of the invention, more restriction members are disposed in a zone where the misaligned winding of the tape is likely to occur. Also, the resilient forces to be applied from the restriction members through the restriction sheet to the misaligning tape edges can be varied locally, as necessary.

Another aspect of the present invention is the tape cartridge in which the restriction means has a plurality of restriction members disposed separately in the rear region, each of the restriction members being formed by folding a portion of the restriction sheet. According to this aspect of the invention, the peripheral edge of the restriction sheet are resiliently forced in contact with the peripheral edges of the tape windings to prevent the misalignment of the tape in a reliable manner. In particular, the restriction sheet can make contacts with the tape windings in the rear-half region, but not in the front-half region, so that the misaligning tape edge is gradually forced into the proper position while moving from the front-half region into the rear-half region.

### BRIEF DESCRIPTION OF THE DRAWINGS

The present invention will become more fully understood from the detailed description and the accompanying drawings, wherein:

FIG. 1A is partial cross sectional view of a tape cartridge of the first embodiment according to the present invention;

FIG. 1B is an enlarged partial cross sectional view of the tape cartridge shown in FIG. 1A;

FIG. 2 is a perspective view of the tape cartridge of the first embodiment according to the present invention;

FIG. 3 is a horizontal cross sectional view of the tape cartridge of the first embodiment according to the present invention;

FIG. 4 is an exploded perspective view of the tape cartridge of the first embodiment according to the present invention;

FIG. 5 is a plan view showing an arrangement of the restriction members of the second embodiment;

FIG. 6 is an enlarged side elevational view showing the restriction member of the second embodiment;

FIG. 7 is a perspective view showing the restriction member of the third embodiment;

FIG. 8 is an enlarged side elevational view showing the restriction member of the third embodiment; and

FIG. 9 is an enlarged side elevational view showing the restriction member of the fourth embodiment.

### DETAILED DESCRIPTION OF THE PREFERRED EMBODIMENTS

The following description of the preferred embodiments is merely exemplary in nature and are in no way intended to limit the invention, its application, or uses.

Referring now to the drawings, wherein like reference numerals designate like or corresponding parts throughout the several drawings, several embodiments of the present invention will be described below.

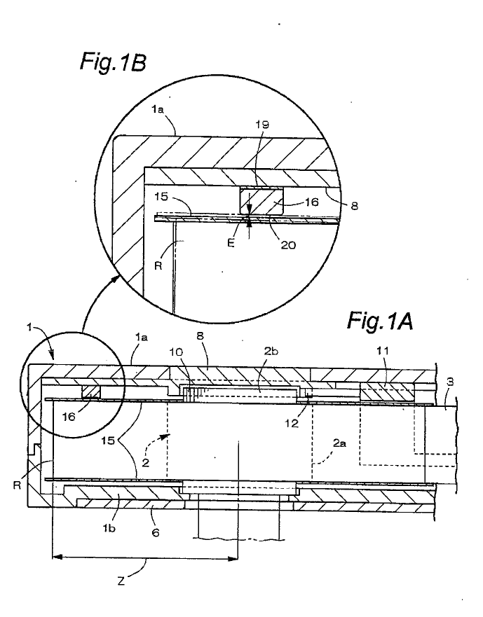

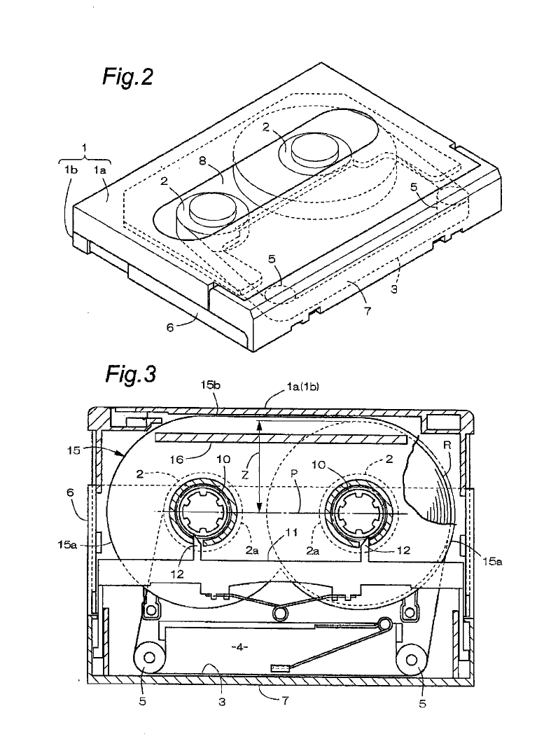

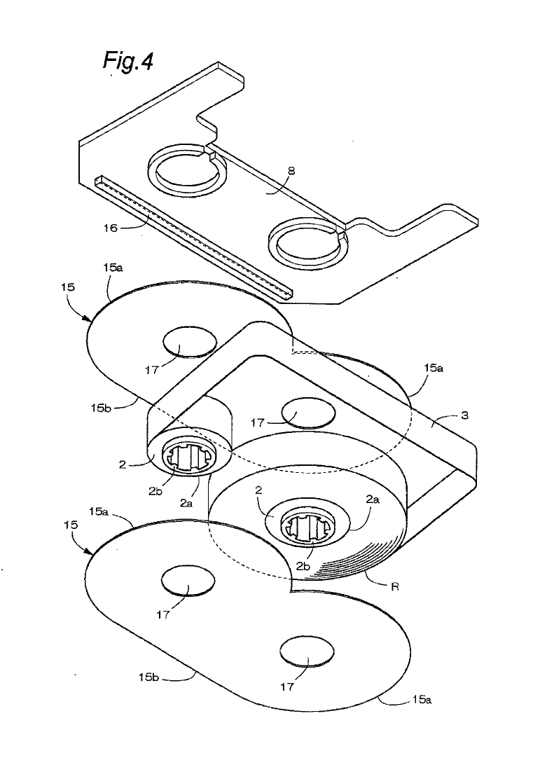

FIGS. 1A to 4 show a first embodiment in which the present invention is embodied in a tape cartridge according to the Digital Audio Tape (DAT) standard and/or the Digital Data Storage (DDS) standard. As best shown in FIGS. 2 and 3, the tape cartridge has a case or tape housing 1. The housing 1 accommodates a pair of tape winding elements 2, each in the form of flange-less hub, provided on left and right sides of an interior thereof and supported by the housing 2 for rotation. A recording tape 3 is wound around the winding elements 2 so that, in operation, incremental portions of the tape wound around one winding element 2 are fed out continuously and then wound by the other winding element 2 and vice versa, during which the tape portions are transported into a loading chamber 4 where data is recorded therein or retrieved therefrom magnetically or optically. The tape may be a magnetic tape for use in the magnetic recording system or an optical tape for use in the optical recording system. Preferably, the housing 1 has an upper housing portion 1a and a lower housing portion 1b, which are connected to each other to form major parts of the housing, i.e., upper wall, lower wall, left and right side walls, and rear wall forming the interior of the housing 1 for accommodating the tape wound.

The loading chamber 4 or pocket is provided at the front portion of the housing 1, into which a portion of the tape is extended out and exposed to outside and supported for data loading by a pair of tape guides 5 in the form of rollers supported for rotation by the housing 1. To prevent the exposed tape portion from being damaged while not in use, a lower opening of the loading chamber 4 is adapted to be selectively closed by a slidable shutter or cover 6. The cover 6 forms a part of the bottom wall of the housing 1 and is supported by the housing 1 for sliding back and forth. The front and upper openings of the loading chamber 4 is adapted to be selectively closed by another pivotable shutter or cover 7. The cover 7 forms a front wall of the housing 1 and is supported by the housing 1 about coaxially aligned horizontal pivots (not shown) projecting from the side walls of the housing in the longitudinal direction of the housing. The covers 6 and 7 are biased into the illustrated closed positions by respective springs (not shown). When the tape cartridge is loaded into associated tape recording and/or retrieving device (not shown), the covers 6 and 7 are forced into respective open positions.

Preferably, as shown in FIGS. 1A and 2, a window plate 8, preferably made of transparent plastic plate, is securely mounted on an upper internal surface of the housing 1. In particular, the window plate 8 has an extended thicker portion elevated upwardly from the upper surface thereof so that, when mounted on the internal surface, the extended thicker portion engages fittingly in an associated opening defined in the upper wall of the housing.

Each of the tape winding elements 2, having a double tube structure, has a cylindrical hub 2a for winding the tape therearound and a cylindrical driving boss 2b securely mounted in the hub 2a. The driving boss 2b has an axial length that is longer than that of the hub 2a so that upper and lower ends thereof are projected from the corresponding upper and lower ends of the hub 2a, respectively. The driving boss 2b has an internal spline defined in the internal peripheral surface thereof so that a driving shaft of the tape drive (both not shown) is adapted to be inserted for engagement into the interior of the boss 2b. The driving boss 2b also has an external gear or locking gear 10 defined on the upper external peripheral surface portion projected from the hub 2a.

A hub-locking member 11 is provided to cooperate with the locking gear 10 and thereby to prevent the rotation of the winding element 2 when in not use. For example, the hub-locking member 11 in the form of elongate plate has a pair of locking portions or nails 12 extending backward and is mounted underneath the upper housing portion 1a and the window plate 8 so as to move backward and forward, between a locking position in which the locking nails 12 are engaged with respective locking gears 10 of the winding elements 2 and a unlocking position in which the locking nails 12 are disengaged from respective locking gears 10, in response to the pivotal closing and opening movements of the pivot cover 7.

In order to prevent not only the misaligned winding of the tape 3 which might otherwise occur when winding the tape around the tape winding element 2 and but also the inclinations of the tape winding elements 2 which might otherwise occur when winding the tape around the winding element 2 and unwinding therefrom, restriction sheets 15 are provided between the internal, upper and lower surfaces of the housing 1 and the opposed upper and lower ends of the hubs 2a, respectively, and one or more restriction means or restriction member 16 preferably made of decreased bouncing ability is provided between the opposed upper internal surface of the housing 1 and the upper restriction sheet 15.

Preferably, the restriction sheet 15 is made from a tough, slippery, and ablation-resistant plastic sheet of, for example, polybutylene terephthalate resin. The sheet 15 is preferably manufactured by punching out the original resin sheet into the illustrated glass configuration with a pair of openings 17 into which the projected upper and lower ends of the driving boss 2b are inserted as shown in FIG. 4. Left and right circular portions 15a of the restriction sheet 15 have a diameter that is slightly larger than the maximum diameter of the tape windings fully wound around the tape winding elements 2. In the embodiment, the restriction sheet 15 has a rear edge 15b extending substantially in parallel to the rear wall of the housing 1 and connecting the left and right circular portions.

As shown in FIG. 4, the restriction member 16 has a rectangular cross section and is in the form of elongate rod. Preferably, the restriction member 16 is made of material with a decreased bouncing ability, such as foamed rubber, foamed plastic, and solid rubber. Preferably, as shown in FIG. 3, the restriction member 16 is positioned on the rear side of the winding elements 2 and within a region indicated by alphabet Z between a first imaginary line P connecting the centers of the left and right winding elements 2 and a second line (not shown) substantially parallel to the first line and tangential to the fully wound tape windings R around one of the winding elements. Most preferably, as shown in FIG. 3, the restriction member 16 is positioned on the rear side of the hubs 2a of the winding elements 2 and adjacent the straight rear edge 15b so that an imaginary line (not shown) extending along the longitudinal axis of the restriction member 16 crosses the circular edges of the left and right circular portions 15a of the restriction sheet 15. As shown in FIG. 1, in this embodiment, the restriction member 16 is secured by the use of suitable adhesive 19 on the window plate 8 fixed on the inner surface of the upper housing 1a.

Preferably, as shown in FIG. 1B, a small gap E is defined between the restriction sheet 15 and the opposed surface 20 of the restriction member 16 when the restriction member 16 is secured on the window plate 8. This intends to prevent the excessive frictional contacts between the restriction member 16 and the restriction sheet 15 during the winding and unwinding operations of the recording tape 3 around the tape winding element 2 while preventing the misalignment of the tape by restricting the longitudinal tape edge by the restriction sheet 15 and the backup restriction member 16 supporting the restriction sheet 15. For this purpose, preferably the gap E is set to be about 0.3 mm or less. However, the gap may be eliminated in some modifications and it should be noted that those modifications also fall within the scope of the present invention.

As above, the addition of the restriction member 16 allows that, when the restriction sheet 15 is forced outward by the misaligning tape edge, the restriction member 16 receives and forces the forced restriction sheet 15 and the winding tape into respective proper positions, which reliably prevents the misalignment of the tape. Also, since the restriction member 16 is made of lower bouncing ability material, it deforms while absorbing forces applied from the restriction sheet 15 and returns the restriction sheet 15 and the tape slowly, but not instantly, which prevents the unwanted bending and/or wearing of the tape.

It is to be noted that a non-stationary impactive tape tension may cause a forward inclination of the tape winding element 2 as well as tape windings R. In this instance, if the inclination of the tape winding element 2 exceeds a certain angle corresponding to the gap E, the misaligning tape movement is restricted by the restriction member 15 to prevent further upward movement of the tape windings R. An amount of elastic deformation of the restriction member 16 and also the resultant its bouncing force increase with an increase of an amount of inclination of the tape winding element 2, which gradually reduces the respective inclinations of the tape winding element 2 and the tape windings R to recover proper winding operations free from any misaligned windings of the tape.

Although the restriction member 16 is extended linearly as shown in FIGS. 3 and 4, the opposite ends thereof may be curved along the circular peripheral edges of the left and right circular portions 15a of the restriction sheet 15. Alternately, a plurality of restriction members 15 are provided in the rear-half region Z in a manner that each extends radially outwardly from the tape winding members 2, for example.

### Second Embodiment

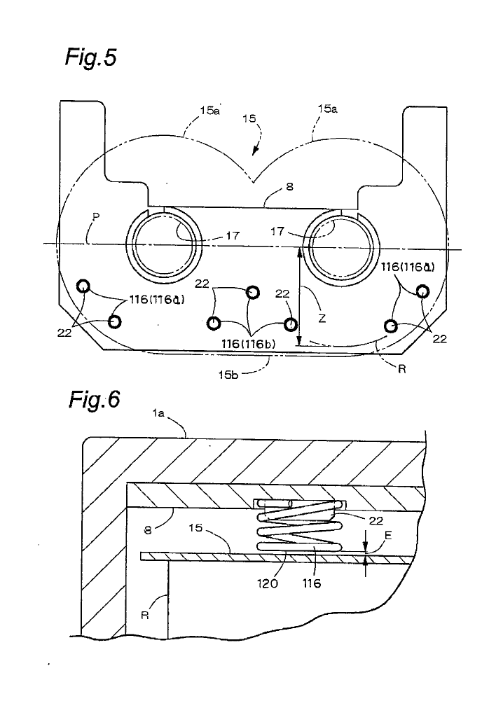

FIGS. 5 and 6 show another embodiment of the restriction means. In this embodiment, the restriction means has a plurality of restriction members 116. The restriction member 116 is a compressive coil spring made of plastic or metal material with a lower bouncing ability. The coil springs are provided separately in the rear-half region Z, opposing the tape wound R. For example, as best shown in FIG. 5, two restriction members 116a are provided for the left and right regions of the restriction sheet 15, opposing the left and right corners of the housing 1 and adjacent the rear left and right circular peripheral edge portions of the restriction sheet 15, and three restriction members 116b are provided for the central region between the left and right regions. Preferably, each of the coil springs 116 is supported by the window plate 8 or the housing 1. For example, in this embodiment, as shown in FIG. 6, the upper end of the coil is securely fitted on an associated projection 22 formed on the internal surface of the window plate 8 so that the other lower end 120 thereof opposes the restriction sheet 15, preferably leaving a small gap therebetween.

Although the coil spring is used for the restriction member, other types of springs such as disc spring may be used instead.

### Third Embodiment

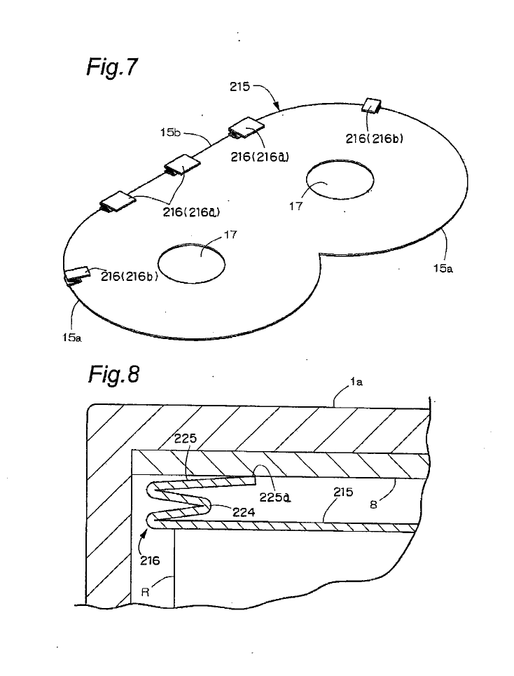

FIGS. 7 and 8 show another embodiment of restriction means. In this embodiment, the restriction means has a plurality of restriction members 216. Each of the lower bouncing ability restriction members 216 are provided separately by bending respective portions of the restriction sheet 215 within the rear-half region Z of the tape windings R. Specifically, the restriction sheet 215 has extensions each formed integrally therewith and extended outwardly from its portions of the rear-linear straight edge and the left and right corner peripheral edges. In this embodiment, three restriction members 216a are provided at the rear straight edge, preferably at regular intervals, and one restriction member 216b is provided at left and right peripheral edges. Preferably, each of the extensions 216 is folded over one or more times to provide a bouncing ability thereto. In this embodiment, each extension is folded over three times to form an inwardly directed folded portion 224 and an inwardly directed contact portion 225, so that, when the restriction sheet 215 so constructed is installed within the housing 1, the distal ends 225a of the contact portions 225 are elastically forced against the window plate 8 and thereby the restriction sheet 215 is slightly forced against the tape windings R.

### Fourth Embodiment

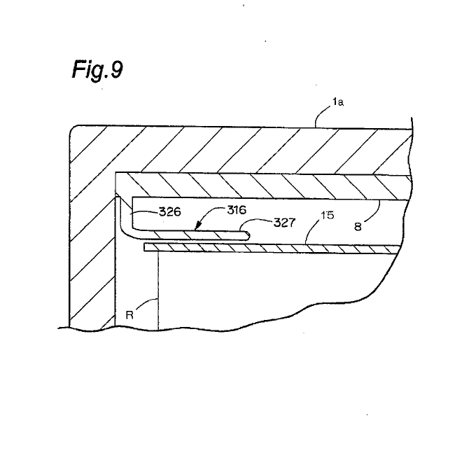

FIG. 9 shows another embodiment of restriction means. In this embodiment, the restriction means has a plurality of restriction members 316, although only one restriction member is indicated in the drawing. The restriction member 316, which is formed integrally with the window plate 8, has a base or leg 326 provided adjacent the peripheral edge of the window plate 8 and projected downward from the lower surface of the window plate 8 and a spring arm 327 provided at the lower end of the leg 326 and extended inwardly and substantially parallel to the lower surface of the window plate 8 on or above the restriction sheet 15. Similar to the previous embodiments, the spring arms 327 are extended into the rear-half region Z (see FIG. 3). Although not limited thereto, the restriction member 316, in particular the spring arm 327, is preferably positioned on imaginary lines (not shown) running across the centers of tape winding elements 2 and perpendicular to the line P connecting the centers of the tape winding elements 2, so that the spring arm 327 receives the restriction sheet 15 forced upward by the misaligning tape edge and returns them in the respective proper positions.

Although the restriction member 316 is formed integrally with the window plate 8, it may be formed integrally with the housing 1 instead or may be an independent component which can be attached to the window plate or the housing with a suitable attaching means including clipping mechanism and adhesive, for example.

Modifications

Although various embodiments of the restriction members are described in the previous embodiments, the arrangement, material, and construction of the restriction member is not limited thereto and they may be modified in various ways. For example, the restriction member may be an air spring such as a small air ball made of flexible material. Also, the restriction members of the first and second embodiments are so combined that the upper end of the coil spring is secured on the window plate and the small-block like restriction member of the first member is coupled to the lower end of the coil spring.

Also, although the restriction members of the first and second embodiments are secured to the window plate, they may be secured to the wall of the housing.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A tape cartridge, comprising:
a housing having upper and lower walls defining an interior therebetween;
a pair of tape winding elements provided on left and right sides of the interior of the housing, the tape winding elements being supported for rotation by the upper and lower walls of the housing;
a tape wound around the tape winding elements;
a restriction sheet provided between the upper wall of the housing and windings of the tape; and
a restriction means made of a lower bouncing material, the restriction means being provided in a region on a rear side of a line connecting centers of the tape winding elements and opposing the windings of the tape and between the upper wall of the housing and the restriction sheet so that, when the restriction sheet is forced toward the upper wall by an edge of laterally moving tape, the restriction means receives the forced restriction sheet and then resiliently returns the restriction sheet toward the tape winding to prevent a misaligned winding of the tape.

2. The tape cartridge of claim 1, wherein the restriction means is secured directly or indirectly to the upper wall of the housing.

3. The tape cartridge of claim 1, wherein the restriction means is made of resilient rubber or plastic material.

4. The tape cartridge of claim 2, wherein the restriction means has an elongate rod-like restriction member made of resilient rubber or plastic material, the restriction member being extended from left to right in the region.

5. The tape cartridge of claim 1, wherein the restriction means has a plurality of restriction members disposed separately in the rear region, each of the restriction members being made of a compressive coil spring.

6. The tape cartridge of claim 1, wherein the restriction means has a plurality of restriction members disposed separately in the rear region, each of the restriction members being formed by folding a portion of the restriction sheet.
